(19) United States
(12) Patent Application Publication
(10) Pub. No.: US 2010/0019052 A1
(43) Pub. Date: Jan. 28, 2010

(54) LINE VOLTAGE THERMOSTAT WITH ENERGY MEASUREMENT MECHANISM

(76) Inventor: Chiu Ming YIP, Markham (CA)

Correspondence Address: BENNETT JONES LLP, 3400 ONE FIRST CANADIAN PLACE, PO BOX 130, TORONTO, ON, M5X 1A4, CA

(21) Appl. No.: 12/181,004

(22) Filed: Jul. 28, 2008

(51) Int. Cl. G05D 23/19; H05B 1/02

(52) U.S. Cl. 236/91 C

(57) ABSTRACT

A thermostat with an energy measurement or calculation mechanism suitable for use with a line powered electric device or apparatus. According to an embodiment, the thermostat includes a switch, a controller and a sensing circuit. The switch is coupled between a power supply line and output line for powering the electric device and operatively connected to the controller. The thermostat includes a temperature sensing component and the controller operates the switch to power the electric device to achieve the desired temperature. The controller operates the sensing circuit to take voltage and/or current measurements which are then used to calculate power consumption and energy consumption values for the operation of the device.

### FIELD OF THE INVENTION

The present invention relates to thermostats, and more particularly, to a thermostat for a line powered device or apparatus and including an energy consumption mechanism.

### BACKGROUND OF THE INVENTION

Line voltage thermostats are known in the art for controlling heating equipment, typically baseboard heaters or convection heaters. The thermostat can be adjusted to a temperature set point such that, when the temperature in the conditioned space reaches the set point, the thermostat turns off the heating equipment. The thermostat continues to monitor the temperature in the space and when it drops below the set point, the thermostat turns on the heating equipment until the desired temperature is achieved.

Advances in the art have given rise to programmable thermostats and thermostats with additional functionality. Programmable thermostats allow a user to program the thermostat to automatically change the set-point temperature during various times during the day and/or week. Thermostats now also include the capability for the user to temporarily override the temperature setting and/or permanently hold the set-point temperature.

While existing advances in the art have resulted in thermostats and programmable thermostats with increased functionality, there still remains a need for improvements in the art, particularly, in the area of power consumption determination and management.

### SUMMARY OF THE INVENTION

The present application is directed generally to a thermostat of a line powered device or apparatus and according to an aspect includes an energy consumption calculation mechanism.

According to one aspect, there is provided a thermostat for a line powered device configured for operating in a physical space, the thermostat comprises an input line for receiving an AC supply voltage; an output line for providing the AC supply voltage to the line powered device; a switch coupled between the input line and the output line and being operable in an open state and a closed state; a controller including a temperature control component configured to activate the line powered device for a desired temperature setting by placing the switch into the closed state to provide the AC supply voltage on the output line; a sensing mechanism coupled to the input line and being configured to sense a line voltage reading and a line current reading; the controller includes an input port for receiving the line voltage and the line current readings; and the controller includes an energy calculation component configured to calculate a power consumption value for the line powered device based on the line voltage and the line current readings.

According to another aspect, there is provided a thermostat for controlling a line powered device, the thermostat comprises: an input port for receiving an AC supply voltage; an output port coupled to the line powered device for outputting the AC supply voltage; a switch coupled between the input port and the output port and being operable to connect the input port to the output port to output the AC supply voltage to the line powered device; an analog module having a first input coupled to the input port for inputting a line current reading, and a second input coupled to the switch for inputting a line voltage reading; an analog to digital converter configured with a first channel for converting the line voltage reading into a corresponding digital line voltage reading and configured with a second channel for converting the line current reading into a corresponding digital line current reading; and a controller having an input port coupled to the analog to digital converter and the controller having a component configured for calculating a power consumption value based on the digital line voltage and line current readings.

Other aspects and features will become apparent to those ordinarily skilled in the art upon review of the following description of embodiments in conjunction with the accompanying figures.

### BRIEF DESCRIPTION OF THE DRAWINGS

Reference will now be made to the accompanying drawings which show, by way of example, embodiments of the apparatus described herein, and how they may be carried into effect, and in which:

FIG. 1 shows in diagrammatic form a thermostat configured with an electric baseboard heater according to an embodiment of the present invention;

FIG. 2 shows in schematic form an implementation of the thermostat of FIG. 1 according to an embodiment of the present invention; and

FIG. 3 shows in schematic form an energy measurement mechanism for the thermostat of FIG. 2 according to an embodiment of the present invention.

Like reference numerals indicate like or corresponding elements in the drawings.

### DETAILED DESCRIPTION OF THE EMBODIMENTS

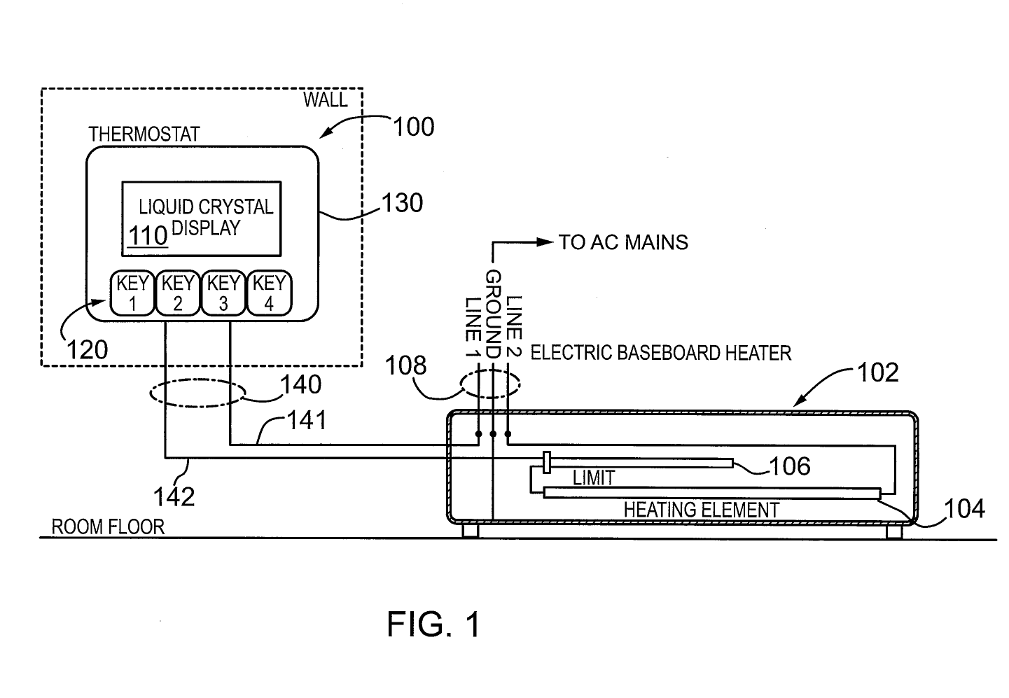

Reference is first made to FIG. 1, which shows in diagrammatic form a thermostat with an energy measurement or consumption calculation mechanism according to an embodiment of the invention and indicated generally by reference 100.

In the figures, like reference numerals indicate like or corresponding elements.

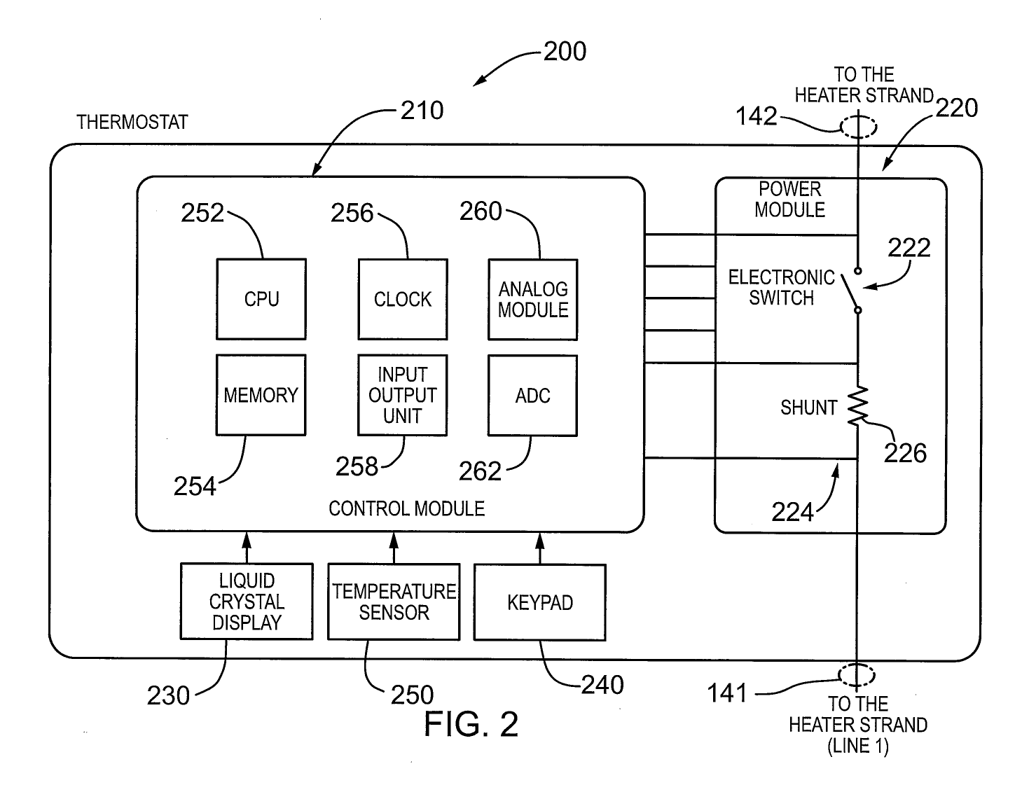

As shown in FIG. 1, the thermostat 100 comprises a display 110 and a keypad 120. The display 110 and the keypad 120 are mounted in a housing or enclosure 130 and operatively coupled to a control module. A control module 250 according to an embodiment of the present invention is described in more detail below with reference to FIG. 2. As shown, the thermostat 100 includes an interface 140 for connecting or coupling to an electric baseboard heater indicated by reference 102. The baseboard heater 102 is implemented in a conventional manner and comprises a heating element 104 and may include a limit element 106, which is configured to shut off the heating element 104 if a safe operating temperature or condition is exceeded. The electric baseboard heater 102 receives power from an AC mains supply in a conventional manner, i.e. with a three terminal electrical connection 108 comprising, Line 1 (power), Line 2 (neutral) and Ground. According to an embodiment, the interface 140 is coupled or wired internally to the electric baseboard heater 102 and comprises a two wire configuration, with one wire 141 coupled or connected to the power line (i.e. Line 1) from the AC mains supply, and another wire 142 providing the power feed for the baseboard heater 102. This configuration allows the thermostat 100 to connect directly to the electric baseboard heater 102 and function as a control switch to directly control the current passing through the electric baseboard heater 102.

It will be appreciated that while embodiments according to the present invention are described in the context of an electric baseboard heater or a line powered space heater, the embodiments have wider applicability to other types of line powered devices or apparatus.

Referring to FIG. 1, the keypad 120 is configured with a number of keys or buttons that allow a user to select a desired temperature setting, set the clock, or for a programmable thermostat, buttons for programming the thermostat, for example, to one or more temperature settings based on time. According to another aspect, the keypad 120 includes one or more keys to allow a user to enter power consumption and/or energy information for the electric baseboard heater 102 (for example, based on the marked ratings of the heater). This information can then be provided by the energy measurement mechanism, for example, in the context of heater protections/warnings, as described in more detail below.

As will be described in more detail below, the thermostat 100 according to an embodiment of the present invention includes an energy measurement mechanism which is configured to operate with the two wire connection to the electric baseboard heater 102 to measure true RMS (i.e. Root Mean Square) values for the voltage and current from the AC mains supply, and using the measured values determine values for active power and energy consumption. According to another aspect, the determination of the values for active power and energy consumption are responsive to user settings and/or adjustments.

Reference is next made to FIG. 2, which shows an implementation of the thermostat 100 of FIG. 1 according to an embodiment of the present invention, and is indicated generally by reference 200. According to an embodiment, the thermostat 200 comprises two modules: a control module indicated by reference 210 and a power module indicated by reference 220. The power module 220 is configured to interface with the electric baseboard heater 102 (FIG. 1), or other line powered device for which energy consumption calculations are required or desired. The control module 210 comprises electronic circuits and components configured to provide the functionality as will be described in more detail below.

The power module 220 interfaces with the AC mains supply and is configured to switch the main line current (i.e. the power feed from Line 1 in FIG. 1) to power the electric baseboard heater 102 (FIG. 1). The power module 220 is also configured to generate a DC supply voltage for operating the control module 210. According to an embodiment, the power module 220 comprises a switching device 222 and a shunt circuit 224. The switching device 222 may comprise an electro-mechanical device or a solid state device. According to an embodiment, the switching device 222 comprises an solid state device and is actuated, i.e. opened/closed, in response to one or more control signal(s) generated by the control module 210. The shunt circuit 224 provides a current sensing function and according to an embodiment comprises a resistor 226 which generates a voltage signal for the control module 210 based on or proportional to the line current, i.e. Line 1.

The control module 210 is configured to control the switching device 222 in order to power the electric baseboard heater 102 (FIG. 1) and provide a regulated heat output according to a setting (i.e. temperature setting or thermostat set point) set by a user. According to another aspect and as will be described in more detail below, the control module 210 is configured to measure line parameters and calculate energy consumption values, i.e. without user intervention. The calculated total usage time and total energy are displayed and can be used by the user in a cost calculation or comparison.

According to an embodiment, the control module 210 comprises a central processing unit (CPU) 252, a memory module 254, a clock 256, an input/output module 258, an analog module 260 and an analog-to-digital (ADC) converter 262. The Liquid Crystal Display (LCD) module 110 (FIG. 1) is indicated by reference 230 in FIG. 2, and is operatively coupled to the control module 210. The keypad 140 (FIG. 1) is indicated by reference 240 in FIG. 2, and is operatively coupled to the control module 210. As shown, the thermostat 200 includes a temperature sensor 250, which is operatively coupled to the control module 210 and provides temperature readings or data for the physical space which is being heated by the electric baseboard heater 102 (FIG. 1). The control module 210 also includes a power supply circuit (not shown), which taps power from the AC input line 141 (i.e. Line 1) and converts it into a DC voltage for powering the control module 210 and the associated DC devices and circuitry in the thermostat 200.

According to an embodiment, the CPU 252 operates under stored program control, i.e. the CPU 252 executes a program or instructions (e.g. firmware) stored in the memory module 254. The program controls the operation of the CPU 252 and provides the functions and features associated with the thermostat 100 as described in more detail below. In addition to non-volatile memory media, the memory module 254 can also include volatile memory media (e.g. RAM or FLASH ROM) for storing data, program variables and other information required or used by the program.

The clock 256 is configured to generate a time-base for the CPU 252 and also to generate a real time clock for display on the LCD 230. The input/output module 258 comprises a number of input and output ports. The input/output module 258 is responsive to the CPU 252 to generate output signals on one or more of the output ports. The output ports include an output port for controlling the operation of the switching device 222, an output port for writing data to be displayed to the LCD module 230. The input ports include an input port for receiving voltage/current readings from the shunt circuit 224, an input port for receiving temperature data from the temperature sensor 250, an input port for receiving keypad signals from the keypad 240. The analog module 260 is operatively coupled to the CPU 252 via the ADC 262 and provides an interface between the AC line 141 and power module 222. As will be described in more detail below, the analog module 260 comprises analog circuits including a zero crossing detector, as will be described in more detail below. The ADC 262 comprises an analog-to-digital converter which is operatively coupled to the CPU 252 and configured to convert an analog input signal (e.g. AC voltage and/or current readings from the shunt circuit 224) into a corresponding digital signal which is then processed by the program executed by the CPU 252, as will be described in more detail below according to an embodiment.

It will be appreciated that while the control module 210 has been described as comprising a CPU, a memory module and other circuit modules or resources, the control module 210 may be implemented in the form of a microcontroller with on-chip resources comprising the memory, the clock, the input/output module and the ADC. According to another embodiment, the control module 210 may be implemented in the form of a programmable device (e.g. a Field Programmable Gate Array or FPGA) and/or dedicated hardware circuits.

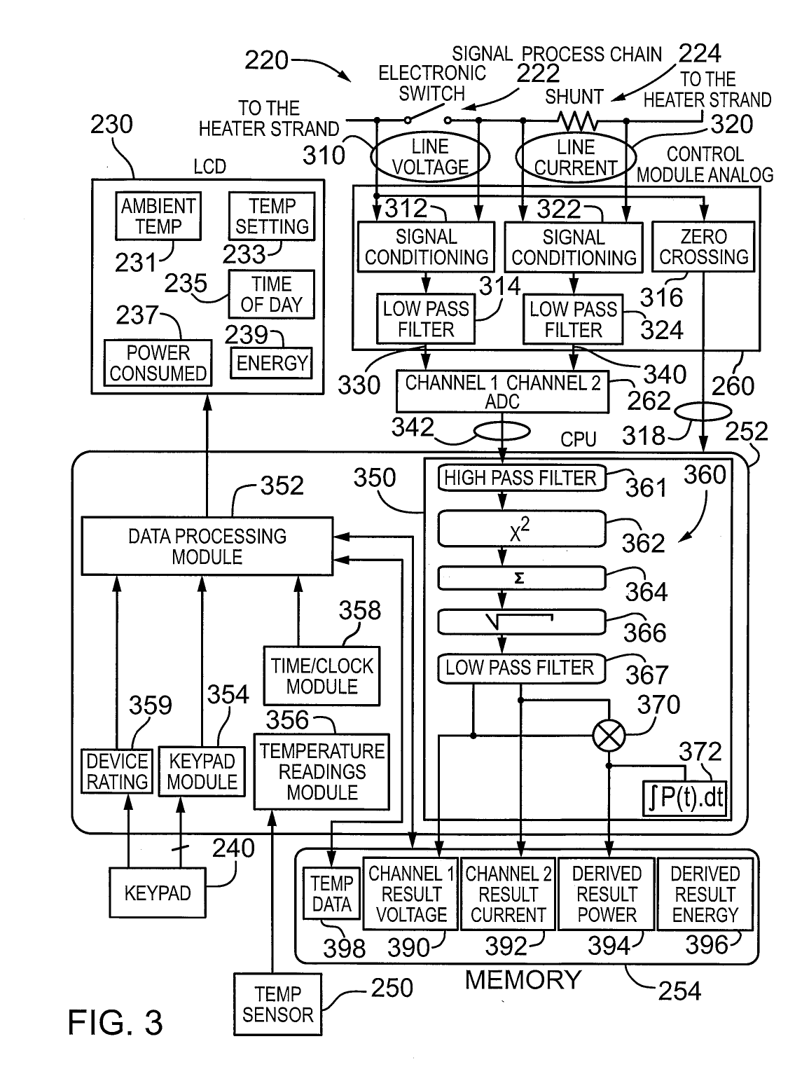

Reference is next made to FIG. 3, which shows an implementation of thermostat with an energy measurement or consumption calculation mechanism according to an embodiment of the invention. The energy measurement mechanism is described in the context of the signal processing that is performed by the CPU 252 and comprises a number of functions or processes that are executed by the CPU 252 in conjunction with the processing or conditioning of signals in the analog module 260 and the ADC 262.

As shown in FIG. 3, the analog module 260 includes an input port 310 coupled to the switching device 222 for inputting line voltage readings, and an input port 320 coupled to the shunt circuit 224 for inputting line current readings. As shown, the analog module 260 includes a signal conditioning circuit 312 configured to condition the line voltage readings received at the input port 310. According to an embodiment, the signal conditioning circuit 312 comprises an attenuator configured to attenuate the line voltage signal to a level suitable for the ADC 262. The conditioned output from the signal conditioning circuit 312 is fed to a filter 314. According to an embodiment, the filter 314 comprises a low pass filter configured to remove higher frequency noise and also alleviate aliasing. The output from the low pass filter 314 is fed to the ADC 262. As shown, the ADC 262 comprises a two channel device having a first channel 330 for digitizing the conditioned line voltage signals received from the low pass filter 314. As shown, the analog module 260 includes a zero crossing detector circuit indicated by reference 316. The zero crossing detector 316 is configured to detect when the AC line voltage crosses zero, i.e. transitions between positive/negative and negative/positive, and generate an output signal that is coupled to an input port 318 on the CPU 252 for further processing under the control of the program stored in memory.

Referring again to FIG. 3, the analog module 260 includes another signal conditioning circuit 322 configured to condition the line current readings received at the input port 320. According to an embodiment, the signal conditioning circuit 322 comprises an amplifier configured to amplify the line current signal to a level suitable for the ADC 262. The conditioned output from the signal conditioning circuit 322 is fed to a filter 324. According to an embodiment, the filter 324 comprises a low pass filter configured to remove higher frequency noise and also alleviate aliasing. The output from the low pass filter 324 is fed to a second channel on the ADC 262 for digitizing. As shown, the output, i.e. the digital stream, from the ADC 262 is received by the CPU 252 at an input port 342.

According to an embodiment, the CPU 262 executes a function or process (i.e. in firmware) to operate the ADC 262 to process one channel at a time. Under the control of the function, the CPU 252 closes the switching device 222 to take a line current measurement at the input port 320 which is digitized through the second channel 340 of the ADC 262. To take a line voltage measurement, the CPU 252 opens the switching device 222 and the line voltage reading at the input port 310 is conditioned (the signal conditioning circuit 312) and filtered (the low pass filter 314) and digitized through the first channel 330 of the ADC 262 for further processing by the CPU 252.

As shown in FIG. 3, the CPU 252 is configured with an energy calculation module implemented in firmware and indicated generally by reference 350. The energy calculation module 350 includes a RMS calculation algorithm indicated by reference 360. The RMS calculation algorithm 360 is implemented as will be understood by one skilled in the art to calculate true RMS values for the line voltage readings 330 and the line current readings 332 digitized by the ADC 262. As shown, the RMS calculation algorithm 360 comprises a processing step 362 for squaring the digitized sample (i.e. the line voltage reading or the line current reading). Prior to the squaring operation 362, the digitized line voltage or line current readings may be passed through a high pass filter function as indicated by reference 361. The squaring step 362 is followed by a summing operation or step as indicated by 364. In the summing step 364, the squared value from step 362 is added to the previous summed value, i.e. Sum=Sum+New Sample. The squaring 362 and summing 364 operations are repeated for a number or set of digitized readings, and then the summed value is divided by the number of readings as indicated by 366 to determine the Root Mean Square value for measured line voltage or measured line current. For example, the RMS (Root Mean Square) value is calculated as follows:

RMS=Square Root((V*V1+V2*V2+V3*V3+ . . . +V(n−1)*V(n−1)+Vn*Vn)/n)

As also shown, a low pass filtering operation may be applied as indicated by reference 367. The CPU 252 then stores the calculated voltage value(s) in a voltage reading table 390 (or other data structure) in the memory module 254. Similarly, the CPU 252 stores the calculated current value(s) in a current reading table 392 in the memory module 254.

Referring again to FIG. 3, the energy calculation measurement module 350 includes a function or process indicated by reference 370 for calculating power. According to an embodiment, the power calculation process 370 comprises a multiplier (e.g. implemented in firmware) which takes a calculated voltage measurement (e.g. retrieved from the table 390 in the memory table 390) and multiplies it with a calculated current measurement (e.g. retrieved from the table 392 in the memory module 254) to determine a power consumption value, for example, in Watts or Kilowatts. According to another aspect, the energy calculation module 350 includes an integrator function indicated by reference 372 for calculating an energy consumption value for the electric baseboard heater 102 (FIG. 1). The integrator 372 determines the energy consumption (for example, in Kilowatt hours) based on the calculated power value and a time value or period. The time value or period for calculating the energy is determined by the CPU 252 through a time/clock processing function 358. According to another aspect, the time/clock processing function 358 is configured to determine operating time intervals and/or a total time of operation for the electric baseboard heater 102.

According to an embodiment and as shown in FIG. 3, the CPU 252 is configured with a data processing module or component 352, a keypad processing module or component 354, a temperature processing module or component 356 and a time/clock processing module or component 358. According to an embodiment, these module or components are implemented as functions or processes in firmware or software and comprise executable instructions which are executed by the CPU 252. The data processing module 352 is configured to process input/output data and control the overall operation and functions of the thermostat 100, for example, controlling operation of the switching device 222, controlling operation of the ADC 262, executing the RMS calculation algorithm 360, performing the power calculation 370, performing the energy calculation 372, writing data to be displayed to the LDC module 230, processing key presses from the keypad module 354, processing temperature measurement from the temperature readings module 356, processing time measurements from the time/clock module 358. The keypad module 354 is configured to receive and process (i.e. debounce) the key presses on the keypad 240. The particular implementation details for the firmware modules to provide the functionality for the operation of the thermostat as described herein will be within the understanding of one skilled in the art.

According to an embodiment, the data processing module 352 is configured to display an ambient temperature reading 231 and a preset (i.e. user) temperature setting 233 on the LCD module 230. The user uses the keypad 240 to enter the temperature setting and other inputs for controlling the operation or programming of the thermostat 100. According to another embodiment, the thermostat 100 includes a programmable feature, and the data processing module 352 is configured to display the ambient temperature reading and one or more preset temperature settings and associated time periods. According to another aspect, the data processing module 352 is configured to display a real-time clock 235 (e.g. 12 or 24 hour) on the LCD 230.

According to another aspect, the CPU 252 is configured with a device rating module 359. The device rating module 359 is configured to allow a user to input power consumption and/or energy rating information or parameters for the electric baseboard heater 102, for example, based on the marked rating(s) for the heater 102. The data processing module 352 is configured to display these ratings 237, 239 in addition to and/or instead of the actual calculated power consumption and energy values. According to another aspect, the data processing module 352 is configured with a function to compare the actual power and energy consumption values with the rated values. This information can then be used to determine whether the heating apparatus is operating efficiently, needs to be repaired or replaced, etc. According to an embodiment, the CPU 252 is configured to execute a function which uses the given heater rating and the measured (calculated) power to detect an open circuit condition in the heater 102. For example, an open circuit condition can occur if the heater 102 is shut down by a safety cutoff circuit in response to an unsafe operating condition, such as a dust buildup or a disconnected wire. According to another embodiment, the CPU 252 is configured to execute a function which monitors one or more heaters 102 (for example, arranged in a group) and based on the calculated energy consumption values a determination (e.g. the function compares the given heater rating to the total calculated power value) is made if one or more of the heaters 102 is faulty or not operating according to its given rating. According to another embodiment, the CPU 252 is configured to detect the “loading” of the heater 102 based on the calculated energy consumption value, for example, a heater which is operating above the given heater rating.

In operation, a user enters a desired temperature setting using the keypad 240. The temperature setting is stored in the memory module 254, and the CPU 252 executes a function to measure the actual room temperature using the temperature sensor 250. If the measured temperature is below the desired user temperature (i.e. set point temperature), the CPU 252 controls the switching device 222 to supply electrical power to the electric baseboard heater 102 and activate the heating element 104 to heat the room or physical space. When the switching device 222 is turned on, i.e. closed, the CPU 252 can also measure the line current and calculate RMS line current values which are then stored in the memory module 254. Similarly, when the switching is turned off, i.e. open, the CPU 252 can measure the line voltage and calculate RMS line voltage values which are also store in the memory module 254. For example, the CPU 252 is configured to sample the line voltage and/or the line current at a pre-defined sampling interval. The stored line voltage and line current values are then used to make power and/or energy calculations, for example, at pre-defined intervals for display on the LCD module 110 or in response to a user input (e.g. power or energy key press).

While the embodiments according to the present application have been described in the context of a line powered electric baseboard heater, it will be appreciated that the embodiments may be extended or find application in other types of electrical or line powered devices.

The present invention may be embodied in other specific forms without departing from the spirit or essential characteristics thereof. Certain adaptations and modifications of the invention will be obvious to those skilled in the art. Therefore, the presently discussed embodiments are considered to be illustrative and not restrictive, the scope of the invention being indicated by the appended claims rather than the foregoing description, and all changes which come within the meaning and range of equivalency of the claims are therefore intended to be embraced therein.

What is claimed is:

1. A thermostat for a line powered device configured for operating in a physical space, said thermostat comprising:
an input line for receiving an AC supply voltage;
an output line for providing the AC supply voltage to the line powered device;
a switch coupled between said input line and said output line and being operable in an open state and a closed state;
a controller including a temperature control component configured to activate the line powered device for a desired temperature setting by placing said switch into the closed state to provide the AC supply voltage on said output line;
a sensing mechanism coupled to said input line and being configured to sense a line voltage reading and a line current reading;
said controller including an input port for receiving said line voltage and said line current readings; and
said controller including an energy calculation component configured to calculate a power consumption value for the line powered device based on said line voltage and said line current readings.

2. The thermostat as claimed in claim 1, wherein said temperature control component includes a temperature sensor for taking a temperature reading for the physical space, and said temperature control component is configured to activate the line powered device if said temperature reading varies from said temperature setting.

3. The thermostat as claimed in claim 2, wherein said energy calculation component is configured to calculate an energy consumption value for the line powered device based on said power consumption value and a time interval.

4. The thermostat as claimed in claim 3, farther including a display module operatively coupled to said controller for displaying one or more of said power consumption value, said energy consumption value, said temperature reading and said temperature setting.

5. The thermostat as claimed in claim 4, wherein said controller includes a component configured for determining said time interval, and one or more operating periods for the line powered device.

6. The thermostat as claimed in claim 4, further including a keypad having an input configured for inputting said temperature setting.

7. The thermostat as claimed in claim 4, wherein said keypad includes an input configured for inputting an energy rating for the line powered device, and said controller includes a component configured to compare said energy rating with said calculated energy consumption value.

8. The thermostat as claimed in claim 5, wherein said controller includes a component configured for determining a total time of operation for the line powered device based on said operating periods and a component configured for calculating a total energy consumption value based on said total time of operation.

9. A thermostat for controlling a line powered device, said thermostat comprising:
an input port for receiving an AC supply voltage;
an output port coupled to the line powered device for outputting said AC supply voltage;
a switch coupled between said input port and said output port and being operable to connect said input port to said output port to output said AC supply voltage to the line powered device;
an analog module having a first input coupled to said input port for inputting a line current reading, and a second input coupled to said switch for inputting a line voltage reading;
an analog to digital converter configured with a first channel for converting said line voltage reading into a corresponding digital line voltage reading and configured with a second channel for converting said line current reading into a corresponding digital line current reading; and
a controller having an input port coupled to said analog to digital converter and said controller having a component configured for calculating a power consumption value based on said digital line voltage and line current readings.

10. The thermostat as claimed in claim 9, wherein said controller includes a component configured for determining a time corresponding to an operation interval for the line powered device and a component configured for determining an energy consumption value based on said power consumption value and said time interval.

11. The thermostat as claimed in claim 9, wherein said controller is configured to take said line current reading when said switch is in a closed state.

12. The thermostat as claimed in claim 11, wherein said controller is configured to take said line voltage reading when said switch is in an open state.
